(19) United States
(12) Patent Application Publication
(10) Pub. No.: US 2002/0186518 A1
(43) Pub. Date: Dec. 12, 2002

(54) Overvoltage protection circuit

(76) Inventors: Mutsuo Nishikawa, Nagano (JP); Katsumichi Ueyanagi, Nagano (JP); Katsuyuki Uematsu, Nagano (JP); Akio Kitamura, Nagano (JP)

Correspondence Address: ROSSI & ASSOCIATES, P.O. Box 826, Ashburn, VA, 20146-0826, US

(21) Appl. No.: 10/123,023

(22) Filed: Apr. 15, 2002

(30) Foreign Application Priority Data
Apr. 13, 2001 (JP) 2001-116064

(51) Int. Cl. H02H 3/20

(52) U.S. Cl. 361/91.1

(57) ABSTRACT

The provision of an overvoltage protection circuit that can be structured with a small number of elements in the same semiconductor substrate along with a CMOS integrated circuit to be protected. An overvoltage protection circuit 1 comprising a voltage divider 2 comprising a first resistance element 21 and a second resistance element 22, which divide the voltage that is supplied from an external power supply terminal 11, an inverter circuit 3 comprising a third resistance element 32, and a high voltage MOS transistor 31 which uses as its input the voltage of the voltage division point of this voltage divider circuit 2, and a switching element 4 comprising a high voltage MOS transistor 41 that cuts off excessive voltage supplied to the CMOS integrated circuit 5 to be protected, is fabricated in the same semiconductor substrate as the CMOS integrated circuit 5.

### BACKGROUND OF THE INVENTION

1. Field of the Invention

The present invention relates to an overvoltage protection circuit that protects CMOS integrated circuits used in electric devices, electronic equipment, and so forth in, for example, automobiles, medical equipment, or industry, against overvoltage conditions or surges that may be applied from the power supply, and more particularly relates to an overvoltage protection circuit that can be produced on a semiconductor substrate along with CMOS integrated circuits.

2. Description of the Related Art

In the past a variety of overvoltage protection circuits have been proposed for control systems and for electrical components and electronic components, such as integrated circuits, included in control systems mounted in, for example, automobiles. The electrical components and electronic components for automobiles are used in an environment likely to have relatively large fluctuations in power supply voltage, making it necessary to prevent malfunctions and damage caused by the fluctuations in power supply voltage.

Common conventional overvoltage protection circuits have been structured by attaching a zener diode or a resistance, etc., outside of the IC chip to be protected. However, equipping the zener diode, resistance, etc., externally resulted in an increased number of parts and in increased labor in assembly, leading to increased costs. Because of this, there have been proposals in recent years to incorporate overvoltage protection circuits using bipolar transistors into the IC chips. (See, for example, Japanese Patent Application Laid-open No. H6-254366.)

However, the production of the abovementioned conventional overvoltage protection circuits using bipolar transistors required a BiCMOS manufacturing process, causing a problem with increased manufacturing costs. Furthermore, because the protection circuit comprised many elements and because there were many places wherein the elements had to be made robust to high voltages in preparation for times when the power supply voltage inputted goes to a high voltage, there was also the problem of the protection circuit increasing the physical size of the circuitry, and the problem of increased manufacturing costs due to more complex manufacturing processes.

### SUMMARY OF THE INVENTION

The present invention was the result of careful consideration of the problems described above, and its object is to provide an overvoltage protection circuit that can be structured from fewer elements, and can be equipped in the same semiconductor substrate as the CMOS integrated circuit to be protected.

In order to achieve the object described above, the overvoltage protection circuit of the present invention is equipped with a voltage divider circuit that divides the voltage applied from the outside, an inverter circuit that uses as its input the voltage at the voltage division point of this voltage divider circuit, and a switching element that assumes an OFF state based on the output of the inverter circuit when an excessive voltage is applied, thereby blocking the excessive voltage from being supplied to the CMOS integrated circuit to be protected, and assumes an ON state otherwise, thereby supplying the power supply voltage to the CMOS integrated circuit, where these are all fabricated on the same semiconductor substrate as the CMOS integrated circuit.

Through the present invention, voltage divider circuits that divide the voltage supplied from the outside, inverter circuits that use the voltage at the division points of these voltage divider circuits as an input, and switching circuits that block the supply of excessive voltage to the CMOS integrated circuit are all manufacturing on the same semiconductor substrate as the CMOS integrated circuit to be protected.

In the present invention, the inverter circuit and the switching element may be structured using high voltage MOS transistors. Doing so makes it easier to provide the overvoltage protection circuit with the ability to withstand high voltages. In such a case, the high voltage MOS transistor is a lateral high voltage MOS transistor having a well of a first conductivity type formed in the surface layer of a semiconductor layer of a second conductivity type, by introducing and diffusing an impurity from the surface, a source region of the second conductivity type and an offset region of the second conductivity type, which are fabricated so as to be separate from each other, in the surface layer of the well region of the first conductivity type, by introducing and diffusing an impurity from the surface, a LOCOS oxide layer fabricated on a portion of the surface of the offset region of the second conductivity type, a drain region of the second conductivity type formed in the surface layer of the offset region of the second conductivity type on the side of the LOCOS oxide layer that is far from the source region of the second conductivity type, a gate electrode made of polycrystalline silicon fabricated on the surface of the exposed surface part of the well region of the first conductivity type, between the source region of the second conductivity type and the offset region of the second conductivity type, with a gate isolation layer interposed therebetween, a source electrode equipped on the surface of the source region of the second conductivity, a drain electrode equipped on the surface of the drain region of the second conductivity type, and a base region of the first conductivity type fabricated so as to enclose the source region of the second conductivity type in both the lateral and in-depth directions and so that it has an impurity concentration greater than that of the aforementioned well region of the first conductivity type.

Here the well region of the first conductivity type can be fabricated simultaneously with the well region of the first conductivity type of the CMOS integrated circuit to be protected. Additionally, the offset region of the second conductivity type and the base region of the first conductivity type can be fabricated at the same time as the resistor elements that structure, for example, the voltage divider circuit and the inverter circuit. Moreover, the source region of the second conductivity type, the LOCOS oxide layer, the drain region of the second conductivity type, the gate isolation layer, the gate electrode, the source electrode, and the drain electrode can all be fabricated at the same time as the similar regions, layers, or electrodes in the CMOS integrated circuit to be protected.

When the ON resistance of the switching element is designed to be low in order to control the loss of power or voltage in the switching element of the overvoltage protection circuit, a zener diode having a breakdown voltages that is no more than the maximum rated voltage for the CMOS integrated circuit can be connected between the terminal that provides the power supply voltage to the CMOS integrated circuit to be protected (i.e., the internal power supply terminal) and the ground terminal. When this is done, the breakdown of the zener diode will clamp the voltage supplied to the CMOS integrated circuit at a level no higher than the maximum rated voltage of the CMOS integrated circuit even when the excessive voltage inputted from the outside surges steeply so that the overvoltage protection circuit cannot follow.

Furthermore, a zener diode may be connected between the terminal that supplies the power supply voltage from the outside (i.e., the external power supply terminal) and the ground terminal as well. When this is done, the breakdown voltage of the zener diode will be higher than the voltage at which the switching element switches between ON and OFF, and yet lower than the maximum rated voltage of the inverter circuit or the maximum rated voltage of the switching element, whichever is less. This will cause the breakdown of the zener diode to clamp the voltage supplied to the overvoltage protection circuit to a voltage in the range that will not damage the overvoltage protection circuit, even when there is a high voltage, such as a static electrical shock, applied to the circuit, while still not interfering with the ON/OFF switching operation of the switching element under normal circumstances.

### BRIEF DESCRIPTION OF THE DRAWINGS

The invention will be described in greater detail with reference to the accompanying drawings, wherein:

FIG. 1 is a circuit diagram showing the structure of an overvoltage protection circuit according to a first embodiment of the present invention;

FIG. 2 is a cross-sectional diagram showing an example of the p-type high voltage MOS transistors that structure the overvoltage protection circuit in the first embodiment of the present invention;

FIG. 3 is a circuit diagram showing the structure of an overvoltage protection circuit according to a second embodiment of the present invention; and

FIG. 4 is a circuit diagram showing the structure of an overvoltage protection circuit according to a third embodiment of the present invention.

### DESCRIPTION OF THE PREFERRED EMBODIMENTS

The drawings will be referenced in explaining the forms of embodiment of the present invention.

### First Embodiment

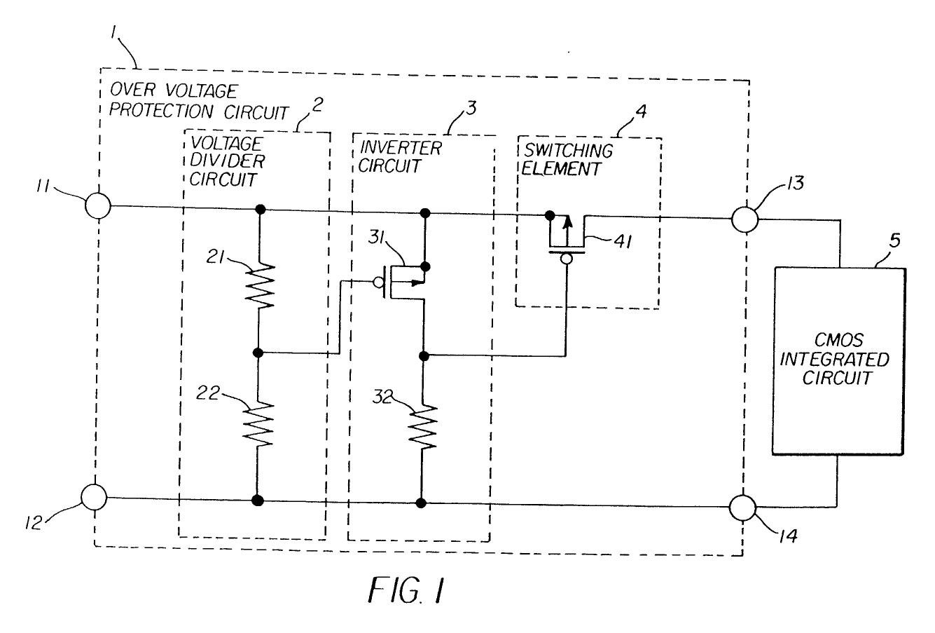

FIG. 1 is a circuit diagram showing the structure of the overvoltage protection circuit in a first embodiment of the present invention. This overvoltage protection circuit 1 is provided with a voltage divider circuit 2, inverter circuit 3, and a switching element 4, and is fabricated in the same semiconductor substrate as the CMOS integrated circuit 5 to be protected. In FIG. 1, 11 is an external power supply terminal that is supplied with a power supply voltage from a source outside the CMOS integrated circuit 5, 12 is the ground terminal that is supplied with a ground potential, 13 is the internal power supply terminal that supplies to the CMOS integrated circuit 5 the power supply voltage that is applied to the external power supply terminal 11, and 14 is the ground terminal that supplies the ground potential to the CMOS integrated circuit 5.

The voltage divider circuit 2 is equipped with, for example, two resistance elements 21 and 22, connected in series. One end of the first resistance element 21 is connected to the external power supply terminal 11, and the other end is connected to one of the second resistance element 22. The other end of the second resistance element 22 is connected to the ground terminal 12 and 14. The inverter circuit 3 is equipped with, for example, a p-type first high voltage MOS transistor (hereinafter abbreviated “first PDMOS”) 31 and a third resistance element 32. In this first PDMOS 31, the source terminal is connected to the external power supply terminal 11, the gate terminal is connected to the connection node between the first resistance element 21 and the second resistance element 22, or, in other words, is connected to the voltage division point. Additionally, the drain terminal of the first PDMOS 31 is connected to one end of the third resistance element 32. The other end of the third resistance element 32 is connected to the ground terminals 12 and 14.

The switching element 4 is equipped with, for example, a p-type second high voltage MOS transistor (hereinafter abbreviated “second PDMOS”) 41. In this second PDMOS 41, the source terminal is connected to the external power supply terminal 11, and the gate terminal is connected to the drain terminal of the first PDMOS 31. In addition, the drain terminal of the second PDMOS 41 is connected to the internal power supply terminal 13.

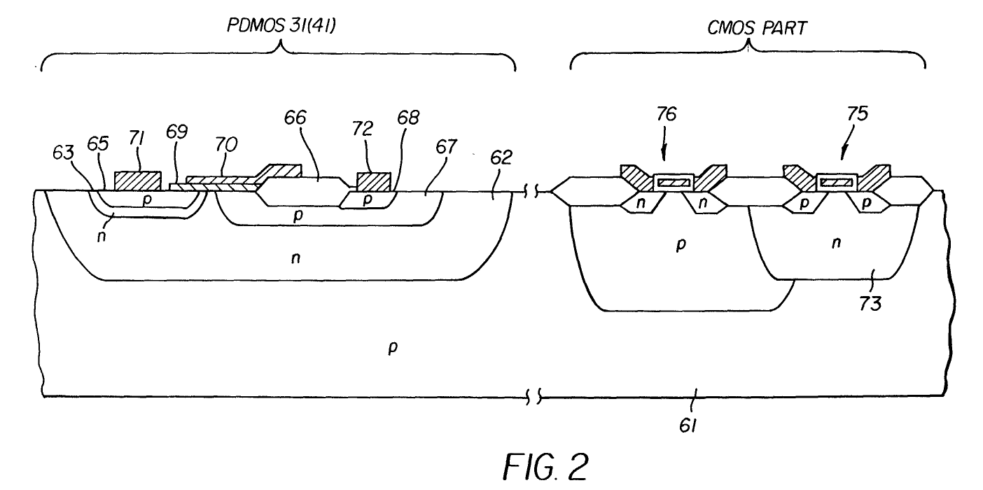

Next, explanations will be given regarding, for example, the structure of the first PDMOS 31 and of the second PDMOS 41. FIG. 2 is a cross-sectional diagram showing an example of the p-type high voltage MOS transistors that structure the overvoltage protection circuit in the first embodiment of the present invention. The left-hand side of FIG. 2 shows a lengthwise cross-sectional diagram showing an example of the structures of the first and second PDMOS 31 and 41, where the right-side of the same figure shows a cross-sectional diagram of the n-channel MOSFET 76 and of the p-channel MOSFET 75 of the CMOS fabricated on the same semiconductor substrate as the PDMOS 31 and the PDMOS 41. An n-well region 62 is fabricated on the primary surface of a p-type substrate 61. The p-offset region 67 and the p-source region 65 are fabricated, slightly separated from each other, in the surface layer of this n-well region 62.

A thick oxide layer (LOCOS) 66 is fabricated selectively on a portion of the surface of the p-offset region 67. In the surface layer of the p-offset region 67, the p-drain region 68 is fabricated on the opposite side from the p-source region 65, lying on opposite sides of the oxide layer 66 from each other. In addition, an n-base region 63 with an impurity concentration that is higher than that of the n-well region 62 is fabricated in the n-well region 62 and lying outside of the p-source region 65. In FIG. 2, 69 is the gate isolation layer, 70 is the gate electrode, 71 is the source electrode, and 72 is the drain electrode.

Here the n-well regions 62 of the PDMOS 31 and the PDMOS 41 are fabricated at the same time as the n-well region 73 in the p-channel MOSFET 75. Consequently, there is no need for any special mask or a process such as ion implantation to fabricate the n-well regions 62 of the PDMOS 31 or the PDMOS 41. The p-offset regions 67 and the n-base regions 63 of the PDMOS 31 and the PDMOS 41 can be fabricated at the same time as the first through third resistance elements 21, 22, and 32, and/or the resistance elements in the CMOS integrated circuit 5. Because of this, there is no need for special masks or for processes such as ion implantation for the p-offset regions 67 or for the n-base regions 63 in the PDMOS 31 and the PDMOS 41 as well. Consequently, the PDMOS 31 and the PDMOS 41 can, in essence, be produced without any special masks or additional processes, and thus the overvoltage protection circuit 1 can be fabricated at the same time as the fabrication of the CMOS integrated circuit 5.

The operation of the overvoltage protection circuit 1, structured as described above, will be explained next. For convenience in explanation, but without limiting the present invention thereto, the respective resistance values of 40 kΩ, 200 kΩ, and 500 kΩ will be used for the first resistance element 21, the second resistance element 22, and the third resistance element 32, respectively, and the maximum rating for the voltage applied to these respective resistance elements 21, 22, and 32 shall be 80V. In addition, the threshold voltage (Vth) of the first and second PDMOS 31 and 41 shall be, for example 1.0V, where the source-drain withstand voltage of these PDMOS 31 and PDMOS 41 shall be 30V, with a source-gate withstand voltage of 7V for each. In addition, the maximum rating for the applied voltage to the CMOS integrated circuit 5 shall be assumed to be 7V.

The situation where the voltage applied to the external power supply terminal 11 is less than 6V will be explained first. The voltage between the source and the gate of the first PDMOS 31 is determined by the difference between the voltage applied to the external power supply terminal 11 and the voltage at the voltage division point of the voltage divider circuit 2. In this case (at less than 6V) the voltage drop across the first resistance element 21 is less than 1V, so the voltage between the source and the gate of the first PDMOS 31 is less than 1V. Consequently, the first PDMOS 31 will be in an OFF state, and there will be a high impedance between the source and the drain.

Because the resistance value is sufficiently larger than that of the third resistance element 32, the voltage at the drain terminal of the first PDMOS 31 is near the ground potential. In other words, the output voltage of the inverter circuit 3 is essentially the ground potential, and thus the second PDMOS 41 will be in an ON state. Consequently, the voltage that is supplied to the external power supply terminal 11 will be applied to the internal power supply terminal 13 and supplied to the CMOS integrated circuit 5. It is desirable to have a design wherein the ON resistance of the second PDMOS 41 is adequately low, in order to restrict the power and voltage lost in the second PDMOS 41, although this is also dependent on the amount of current consumed in the CMOS integrated circuit 5.

When the voltage supplied to the external power supply terminal 11 goes to 6V, the voltage drop across the first resistance element 21 is 1V, so the voltage between the source and the gate of the first PDMOS 31 is 1V. Consequently, the first PDMOS 31 goes to a partially opened state, and an electric current begins to flow through a path comprising the first PDMOS 31 and the third resistance element 32. At the same time, the voltage at the drain terminal of the first PDMOS 31 begins to rise.

When the voltage supplied to the external power supply terminal 11 increases further and passes 6V, the first PDMOS 31 turns completely on, so the p-ON resistance of the first PDMOS 31 will be substantially lower than the resistance value (500 kΩ) of the third resistance element 32. As a result, the voltage at the drain terminal of the first PDMOS 31 increases sharply until it reaches a value near to that of the applied voltage at the external power supply terminal 11, and the second PDMOS 41, which has this voltage as the input voltage at its gate, rapidly transitions to the OFF state (a high-impedance state). When the second PDMOS 41 is in an OFF state, the ON impedance is substantially greater than the circuit impedance when the CMOS integrated circuit 5 is seen from the internal power supply terminal 13, so the applied voltage at the internal power supply terminal 13 goes to near the ground potential. Because of this type of operation, the voltage applied to the CMOS integrated circuit 5 will be less than the maximum rating of 7V, even when an excessive voltage is applied to the external power supply terminal 11.

According to the first embodiment described above, the voltage divider circuit 2, which divides the voltage supplied from the external power supply terminal 11, the inverter circuit 3, which uses as an input the voltage at the voltage division point of this voltage divider circuit 2, and the switching element 4, which prevents excessive voltage from being supplied to the CMOS integrated circuit 5 to be protected, can be fabricated on the same semiconductor substrate along with the CMOS integrated circuit 5 without the use of special masks, and without additional processes. Consequently, an inexpensive overvoltage protection circuit 1, which can be structured from a small number of elements, can be equipped in the same semiconductor substrate as the CMOS integrated circuit 5.

Although in the example described above the maximum value for the voltage that can be applied to the external power supply terminal 11 was determined by the source-drain withstand voltage of the second PDMOS 41 and, in this case, was 30V, the present invention is not limited to any of the various numeric values used in explaining the embodiment described above, including this 30V value. In particular, the values of the resistances for the first resistance element 21 and the second resistance element 22 need only be resistance values that will supply a voltage such that the first PDMOS 31 will switch to an ON state when a voltage near to the maximum rating for the applied voltage for the CMOS integrated circuit 5 is applied to the external power supply terminal 11. Furthermore, resistance elements can be provided instead of the first PDMOS 31 in the inverter circuit 3, and an n-type high voltage MOS transistor can be provided instead of the third resistance element 32. An n-type high voltage MOS transistor can be provided instead of the first PDMOS 31 and the third resistance element 32.

### Second Embodiment

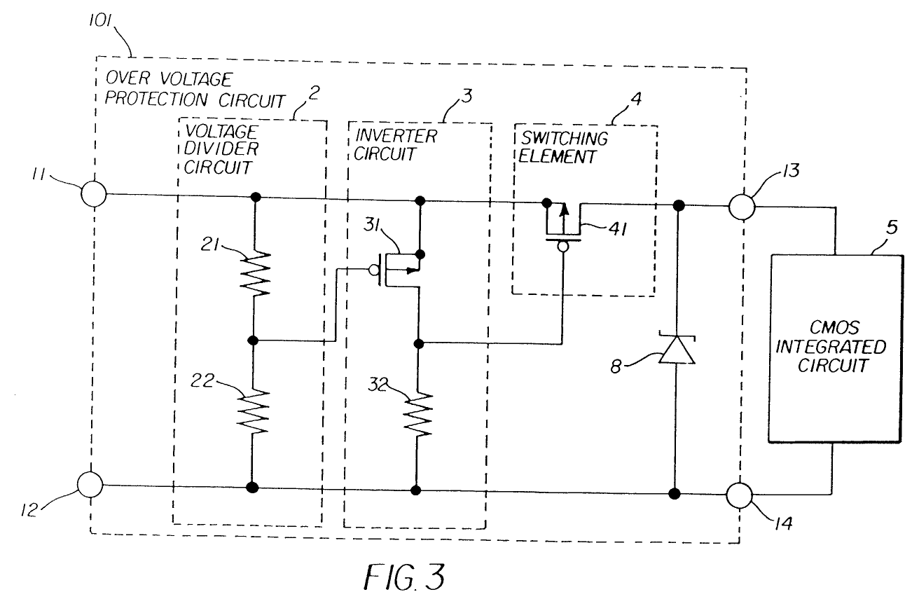

FIG. 3 is a circuit diagram showing the structure of an overvoltage protection circuit according to a second embodiment of the present invention. This overvoltage protection circuit 101 has a zener diode 8 connected between the internal power supply terminal 13 and the ground terminal 14 in the overvoltage protection circuit 11 of the first embodiment. Because the structure is otherwise identical to that of the first embodiment, the same codes have been applied as in the similar structures in the first embodiment and thus the explanation thereof is omitted. The breakdown voltage of the zener diode 8 is established so that it is more than the switching voltage of the second PDMOS 41 (for example, more than 6V in the first embodiment), and less than the maximum rating of the applied voltage for the CMOS integrated circuit 5 (for example, less than 7V in the example in the first embodiment). This is to protect the CMOS integrated circuit 5 from excessive voltage while not interfering with the actual operation of the overvoltage protection circuit.

The overvoltage protection circuit 101 in the second embodiment is effective when an excessive voltage is applied in a sudden surge to the degree that the protection circuit comprising the voltage divider circuit 2, the inverter circuit 3, and the switching element 4 (with these parts corresponding to those in the overvoltage protection circuit 1 of the first embodiment) cannot keep up. In this overvoltage protection circuit 101, the zener diode 8 breaks down for the sudden surge overvoltage input, clamping the voltage at the internal power supply terminal 13, thus protecting the CMOS integrated circuit 5.

Consequently, the second embodiment can obtain the effect of being able to protect the CMOS integrated circuit 5 through the breakdown of the zener diode 8, even when there is a sudden surge overvoltage input, in addition to the effect of being able to provide an inexpensive overvoltage protection circuit 101 that can be constructed from a small number of elements on the same semiconductor substrate along with the CMOS integrated circuit 5. In other words, the surge durability performance of the overvoltage protection circuit 101 is improved. For example the second embodiment is particularly effective in the type of situation wherein the width of the gate in the second PDMOS 41 is increased in order to reduce the power and voltage lost in the second PDMOS 41, causing the ON resistance to be reduced substantially and causing the gate capacitance of this second PDMSO 41 to increase because the gate electrode will have a larger surface area, thereby reducing the speed of the ON-to-OFF switching operation in the second PDMOS 41.

### Third Embodiment

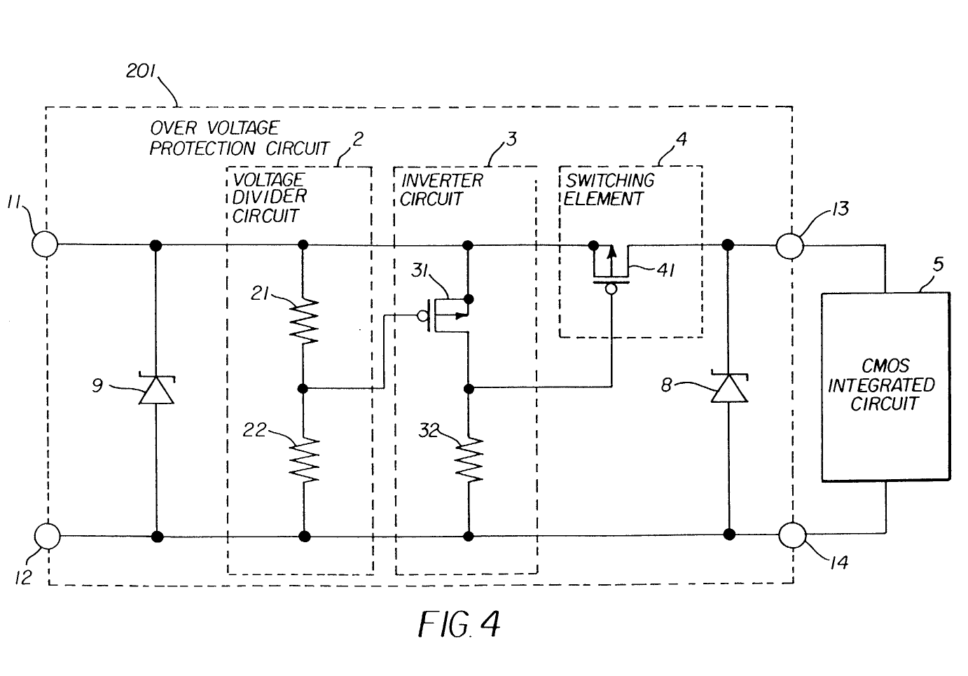

FIG. 4 is a circuit diagram showing the structure of an overvoltage protection circuit according to a third embodiment of the present invention. This overvoltage protection circuit 201 has a second zener diode 9 connected between the external power supply terminal 11 and the ground terminal 12 in the overvoltage protection circuit 101 from the second embodiment. Because the structure is otherwise identical to that of the first embodiment and that of the second embodiment, the same codes are used as for the identical structures in the first embodiment and the second embodiment, and thus the explanations are omitted.

The breakdown voltage of the second zener diode 9 is set so that it is greater than the switching voltage of the second PDMOS 41 (for example, 6V in the example in the first embodiment), and lower than the maximum rating for the applied voltage for the overvoltage protection circuit 201 were the second zener diode 9 not present (i.e., the part corresponding to the overvoltage protection circuit 101 in the second embodiment), (for example of 30V in the first and second embodiments). This setting of the breakdown voltage for the second zener diode 9 is in order to protect the overvoltage protection circuit 201 from an excessive voltage while not interfering with the actual operation of the overvoltage protection circuit.

The overvoltage protection circuit 201 of the third embodiment is effective in cases where a high voltage in excess of the maximum rating for the applied voltage of the overvoltage protection circuit itself is applied to the external power supply terminal 11 (such as in static electric discharge). In this overvoltage protection circuit 201, the second zener diode 9 breaks down with an inputted high voltage in excess of the maximum rating for the applied voltage for the overvoltage protection circuit itself, clamping the voltage supplied to the overvoltage protection circuit 201 at a voltage in a range that does not damage the overvoltage protection circuit 201, thereby protecting the overvoltage protection circuit 201.

Consequently, this third embodiment is effective in that an inexpensive overvoltage protection circuit 201 comprising a small number of elements can be provided in the same semiconductor substrate along with the CMOS integrated circuit 5, and, in addition to being effective in being able to protect the CMOS integrated circuit 5 by the breakdown of the zener diode 8 against the input of a sudden surge voltage, it provides the effect of being able to protect the overvoltage protection circuit 201 through the breakdown of the second zener diode 9 against the input of a high voltage in excess of the maximum rating for the applied voltage for the overvoltage protection circuit itself. In other words, the surge protection performance of the overvoltage protection circuit 201 is further improved.

The present invention is not limited to the various embodiments described above, but can be changed in a variety of ways. This, of course, applies also to the case where the first conductor type is p-type and the second conductor type is n-type.

In the present invention, a voltage divider circuit that divides the voltage supplied from the outside, an inverter circuit that uses as its input the voltage at this voltage division point of this voltage divider circuit, and a switching element that cuts off excessive voltage supplied to the CMOS integrated circuit are fabricated in the same semiconductor substrate as the CMOS integrated circuit to be protected. Consequently, it is possible to provide an inexpensive overvoltage protection circuit structured from a small number of elements in the same semiconductor substrate along with the CMOS integrated circuit to be protected.

What is claimed is:

1. An overvoltage protection circuit, comprising:
an external power supply terminal adapted to receive a power supply voltage;
a ground terminal adapted to receive a ground electrical potential;
an internal power supply terminal for supplying the power supply voltage received by the external power supply terminal to a CMOS integrated circuit that is to be protected;
a voltage divider circuit that is connected between said external power supply terminal and said ground terminal, and that divides the voltage supplied from said external power supply terminal;
an inverter circuit that is connected between said external power supply terminal and said ground terminal and into which the voltage at the voltage division point of said voltage divider circuit is inputted; and
a switching element that is connected between the said external power supply terminal and the said internal power supply terminal, and that switches on and off depending on the output of said inverter circuit;
wherein said voltage divider circuit, said inverter circuit, and said switching element are fabricated on the same semiconductor substrate as said CMOS integrated circuit.

2. The overvoltage protection circuit according to claim 1, wherein said switching element is in an OFF state due to the output of said inverter circuit when an excessive voltage is applied to said external electrode terminal, and conversely, is in an ON state due to the output of said inverter circuit when there is no excessive voltage applied to said external power supply terminal.

3. The overvoltage protection circuit according to claim 1, wherein said voltage divider circuit comprises a series connection of a first resistance element and a second resistance element;
said inverter circuit comprises a series connection of a first high-voltage MOS transistor whose gate terminal is an input terminal and whose drain terminal is an output terminal, and a third resistance element; and
said switching element comprises a second high-voltage MOS transistor whose source terminal is connected to said external power supply terminal, drain terminal is connected to said internal power supply terminal, and gate terminal is connected to the output terminal of said inverter circuit.

4. The overvoltage protection circuit according to claim 1, wherein said first high-voltage MOS transistor is a lateral high voltage MOS transistor that has:
a well region of a first conductivity type formed in the surface layer of a semiconductor layer of a second conductivity type, by introducing and diffusing an impurity from the surface;
a source region of the second conductivity type and an offset region of the second conductivity type, which are fabricated, so as to be separate from each other, in the surface layer of the well region of the first conductivity type, by introducing and diffusing an impurity from the surface;
a LOCOS oxide layer fabricated on a portion of the surface of the offset region of the second conductivity type;
a drain region of the second conductivity type fabricated in the surface layer of the offset region of the second conductivity type, on the side of the LOCOS oxide layer that is far from the source region of the second conductivity type;
a gate electrode made of polycrystalline silicon fabricated on the surface of the exposed surface part of the well region of the first conductivity type, between the source region of the second conductivity type and the offset region of the second conductivity type, with a gate isolation layer interposed therebetween;
a source electrode equipped on the surface of the source region of the second conductivity type;
a drain electrode equipped on the surface of the drain region of the second conductivity type; and
a base region of the first conductivity type fabricated so as to enclose the source region of the second conductivity type in both the lateral and in-depth directions, and that has an impurity concentration greater than that of said well region of the first conductivity type.

5. The overvoltage protection circuit according to claim 1, wherein said second high-voltage MOS transistor is a lateral high voltage MOS transistor that has:
a well of a first conductivity type formed in the surface layer of a semiconductor layer of a second conductivity type, by introducing and diffusing an impurity from the surface;
a source region of the second conductivity type and an offset region of the second conductivity type, which are fabricated, so as to be separate from each other, in the surface layer of the well region of the first conductivity type, by introducing and diffusing an impurity from the surface;
a LOCOS oxide layer fabricated on a portion of the surface of the offset region of the second conductivity type;
a drain region of the second conductivity type fabricated in the surface layer of the offset region of the second conductivity type on the side of the LOCOS oxide layer that is far from the source region of the second conductivity type;
a gate electrode made of polycrystalline silicon fabricated gate isolation layer on the surface of the exposed surface part of the well region of the first conductivity type, between the source region of the second conductivity type and the offset region of the second conductivity type, with an gate isolation layer interposed therebetween;
a source electrode equipped on the surface of the source region of the second conductivity type;
a drain electrode equipped on the surface of the drain region of the second conductivity type; and
a base region of the first conductivity type fabricated so as to enclose the source region of the second conductivity type in both the lateral and in-depth directions, and that has an impurity concentration greater than that of said well region of the first conductivity type.

6. The overvoltage protection circuit according to claim 1, wherein a zener diode is connected between said internal power supply terminal and said ground terminal, and the breakdown voltage of said zener diode is no more than the maximum rated voltage for said CMOS integrated circuit.

7. The overvoltage protection circuit according to claim 1, wherein a zener diode is connected between said external power supply terminal and said ground terminal, and the breakdown voltage of said zener diode is no less than the voltage that causes said switching element to switch ON/OFF, and is no more than the maximum rated voltage for said inverter circuit or the maximum rated voltage for said switching element, whichever is less.
